(19) United States
(12) Patent Application Publication
(10) Pub. No.: US 2008/0289045 A1
(43) Pub. Date: Nov. 20, 2008

(54) Method and device for encoding software to prevent reverse engineering, tampering or modifying software code, and masking the logical function of software execution

(76) Inventor: Thomas Michael Fryer, Lancaster, CA (US)

Correspondence Address: Thomas Fryer, Suite 103, 41319 12th St. W, Palmdale, CA, 93551, US

(21) Appl. No.: 12/154,142

(22) Filed: May 19, 2008

Related U.S. Application Data
(60) Provisional application No. 60/930,796, filed on May 17, 2007.

(51) Int. Cl. G06F 21/00

(52) U.S. Cl. 726/26

(57) ABSTRACT

This invention prevents software from being reverse engineered. The random nature and multiple uses of atoms prevent the analysis of key processes within the software. If an attempt is made to try and duplicate or bypass the program and/or key processes, then this invention will cause the failure of the execution of the software code thereby preventing unauthorized release and/or execution of the code.

### CROSS-REFERENCE TO RELATED APPLICATIONS

This application claims the benefit of U.S. Provisional Patent Application No. 60/930,796, filed on May 17, 2007, which is incorporated herein by reference.

### BACKGROUND

Software processing instructions are concise, clear instructions as created by the designer(s) of said software. Since software instructions must follow an ordered, logical flow of operation, then concealing the logic flow and/or order of operation has depended primarily upon the addition of operations and instructions that do not contribute to the design of the logic flow and/or operation to try and conceal how the software code functions.

Concealment of key processes and/or logic operations of software are important considerations in order to protect the software code from being reverse engineered. Reverse engineering is the process of discovering the technological principles of a device, software program, object or system through analysis of its structure, function, and operation while attempting to create a new software program that does the same thing without copying anything from the original.

The very nature of the logic of programming languages prevents any real attempt to hide or obscure the function of the written and/or executed logic from reverse engineering. Currently, attempts to ‘hide’ key processes from reverse engineering usually follow complex mathematical principals and algorithms that can be observed, understood, and re-created using the principles of reverse engineering. What is needed is a method for preventing reverse engineering of software programs that is robust and addresses the shortcomings of the prior art.

### SUMMARY

This invention grants the creator(s) of software code the ability to protect one or more key processes from reverse engineering or re-compiling the source code by rendering these process(es) illogical and contrary to traditional analysis. This invention is not programming language specific, rather it can be applied to any computer-readable language. While additional security and/or legal protection mechanisms can be employed to protect the integrity of the creator(s) design, this invention is designed to provide a passive defense against compromising the intellectual property of the creator(s).

Reverse engineering depends upon the ability to reconstruct logic events, repeatedly, over a period of time. In accordance with this invention, logic events are interpreted as random events; not following a prescribed logic flow adds tremendous difficulty to reverse engineering analysis. The ‘randomness’ used to apply this invention onto all computer-readable languages makes reconstructing the original premise extremely difficult and highly unlikely.

Application of the invention is not dependent upon the programming language, complexity of the process(es) involved, or the overall length of the actual program itself. This invention can be applied to any computer-readable medium.

### BRIEF DESCRIPTION OF THE DRAWINGS

FIG. 1 illustrates the dependencies between definitions, axioms, and atoms and code generator action;

FIG. 2 is a table describing the individual elements utilized, their role, and relationship to each other;

FIG. 3 is a table showing the types of atoms and the type and number of variables utilized.

FIG. 4 is table showing the types of atoms and the number of invariants used.

### DETAILED DESCRIPTION

The code is divided into components called atoms, most of which do nothing of importance. Code generation will randomly shuffle and duplicate these atoms, making sure that the final result contains multiple copies of all atoms, including those that perform the intended processing. They are called atoms because they are made indivisible, to facilitate the described code generation.

Atoms need to be as independent of other atoms as possible. In order to trick the reverse engineer into thinking they are important, most atoms should execute a nontrivial algorithm and/or test a nontrivial condition. Therefore, to satisfy both requirements of minimum dependency and maximum complexity, there preferably is a set of nontrivial invariants that remain true throughout the execution of associated atoms. For each nontrivial invariant, there preferably is an initialization atom, which is called an axiom atom. An axiom is preferably executed at least once before any atom that requires it's invariant.

Invariants are the driving agents of atom creation. An invariant is made true by the execution of an axiom atom, maintained through atoms that execute nontrivial algorithms, and tested by atoms testing them as nontrivial conditions. Invariants need only be true while atoms require it; they can be made true (with an axiom atom), allowed to become false, and made true again (with another axiom atom) several times in a molecule.

Code generation preferably randomly selects among all atoms. If an atom is selected, the code generator will preferably guarantee that the necessary axiom atoms are present. So that no correlation could be deduced, the code generator will preferably guarantee that all atoms are evenly represented within statistical tolerance. For example, let's begin with an invariant:

x≦y+3

An axiom atom that initializes this invariant could be:

### X=3;

y=0;

All atoms that use the variables x or y preferably succeed this axiom (or one like it), and preferably maintain the invariant.

This brings up another source of dependence; variable definition. The example axiom depends upon the existence of the variables x and y, which is shown in the following two definitions:

int x;
int y;

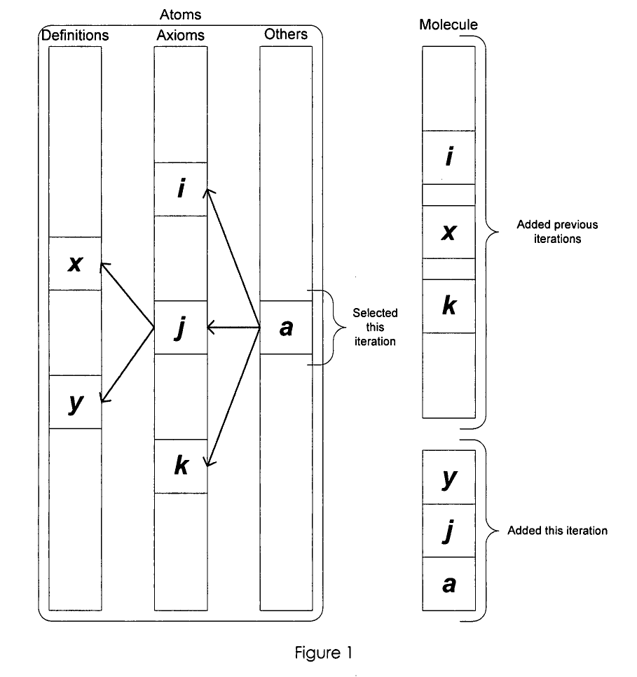

The dependencies between definitions, axioms and atoms, as well as the action of the code generator are shown in FIG. 1.

The generator randomly selects an atom, determines its dependencies, seeks those dependencies in the previous results, and adds the necessary components and definitions. For example, the generator selects atom a, which depends upon axioms i, j and k, and axiom j depends upon definitions x and y. The generator had already added at least one copy each of axioms i and k, and definition x, so the generator needs to add, in order, definition y, axiom j and atom a.

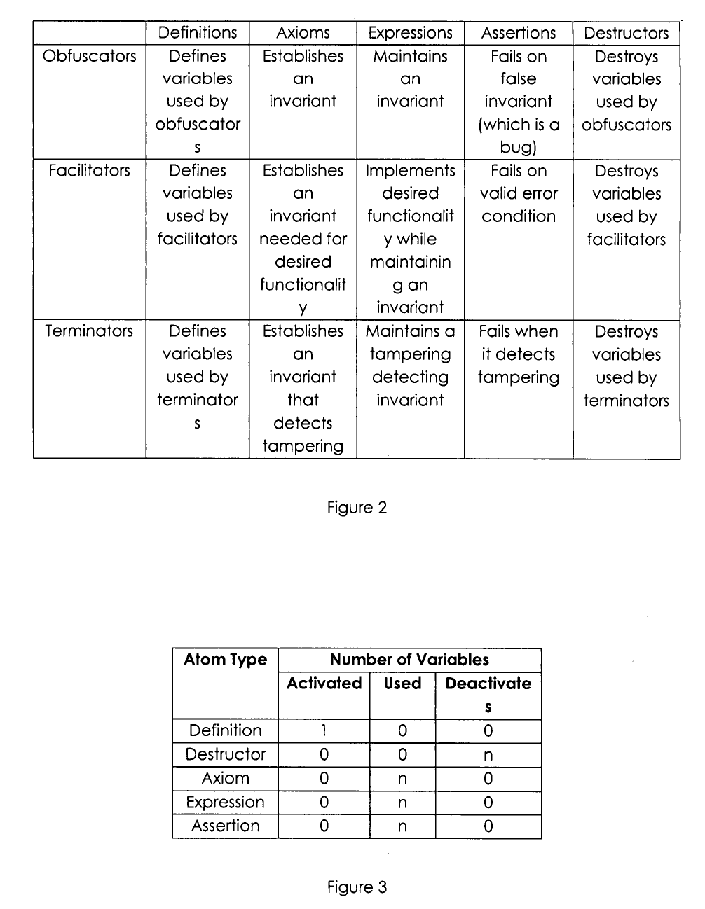

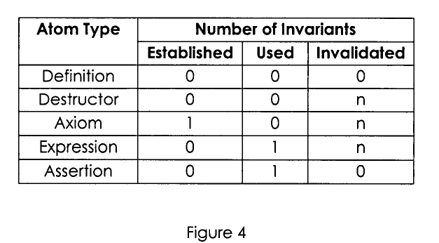

There are preferably five groups of atoms: definitions in which variables are created, axioms in which invariants are established, expressions which maintain invariants, assertions which test invariants, and destructors which destroy variables created in definitions. There are three “periods” of atoms: obfuscators (whose behavior has no bearing on the operation or functionality of the system being obfuscated), facilitators that implement desired functionality, and terminators that detect tampering (such as it being an unauthorized copy). There is alo a sub-period for each type of tempering detected by terminator assertions. FIG. 2 summarizes the above showing the 5 groups of atoms vs. the 3 periods. This figure is referred to as the atoms' periodic table of elements.

### Prerequisites and Dependencies

As a molecule is built, the code generator preferably keeps track of the active and inactive variables. Before an axiom, expression or assertion atom can be appended to the molecule; all variables it uses are preferably active in the molecule at the point of appending.

Variables are active between their associated definition and destructor atoms. It is possible for a given variable to alternate between active and inactive several times. Therefore, after a definition atom is appended, its variable is preferably marked as active. Before any other atom is appended, all of its variables are preferably active, and if any are not, appropriate definition atoms are preferably appended beforehand. After a destructor atom is appended, its variables are preferably marked as inactive.

The code generator can keep track of a molecule's variables with a vector and a matrix. The vector is a single-dimensional table of variables, which are either active or inactive. The matrix is a two-dimensional array indexed by variable and atom, each entry indicating that the specific atom activates, needs, or deactivates the specific variable.

Before any atom other than a definition atom is appended, the variables it needs (or deactivates, in the case of a destructor atom) are preferably active. The variable matrix can be used to identify the definition atoms that activate those variables. For every inactive variable, its associated definition atom is preferably selected and appended.

Each invariants is established by one of a number of axiom atoms, but can be made invalid after a destructor atom, or an axiom or expression atom of another invariant. It is possible for an invariant to alternate between established and invalid several time in a molecule. After an axiom atom is appended, its invariant is preferably marked as established. Before an expression or assertion atom is appended, its invariant is preferably established, and if it isn't, an appropriate axiom atom is preferably appended beforehand. After a destructor, axiom or expression atom is appended, any invariants it invalidates is preferably so marked.

The code generator can keep track of a molecule's invariants with a vector and a matrix. The vector is a single-dimensional table of invariants, which are either established or invalid. The matrix is a two-dimensional array indexed by invariant and atom, each entry indicating that the specific atom establishes, needs, or invalidates the specific invariant. Care should be taken to identify all invariants invalidated by destructor, axiom and expression atoms; they are not as easy to spot as the variables deactivated by destructor atoms.

Before an expression or assertion atom is appended, the invariant it need is preferably established. The invariant matrix can be used to identify the axiom atoms that establish that invariant. If the desired invariant is invalid, one of its axiom atoms is preferably randomly selected and appended.

### Code Generation and Statistical Weights

Invariants drive the creation of atoms and their dependencies, but the atomic selection process drives code generation. Uniform coverage of atoms is achieved by statistical weighting. Every time an atom is added to the resulting “molecule,” its weight for subsequent selection is reduced.

In a preferred embodiment, each atom's statistical weight for selection is the inverse of the number of times it has been previously used. One way to calculate such a weight is

$${P}_{a} = \frac{1 + {\sum }_{i = 1}^{n} {s}_{i} - {s}_{a}}{n + ( n - 1 ) {\sum }_{i = 1}^{n} {s}_{i}}$$

where Pₐ is the probability that atom a will be selected in the next iteration, Sₐ is the number of times atom a has been previously selected, and n is the number of atoms. Calculated in this way, the sum of the probabilities of all atoms can be shown to be unity.

To facilitate maintaining dependencies between atoms, code generation is preferably recursive. A possible implementation could be
Do
   Statistically select an atom A
   Add atom A to the result
Until (the result is large enough) or (all atoms are represented) or (desired functionality has been appended)
   where the second line of the loop is recursively implemented as

For all unsatisfied prerequisite
Statistically select atom B from those atoms

that fulfill the prerequisite
Add atom B to the result

Append atom A to the result

When an atom is selected that represents an inactive invariant, satisfying its dependencies (prerequisites) will automatically establish the necessary invariant.

### INVARIANT EXAMPLES

An invariant need not be a single equation or inequality. Consider the Cartesian/polar coordinate conversion invariant:

$$\begin{matrix}x = r cos θ , & y = r sin θ \\ r = \sqrt{{x}^{2} + {y}^{2}} , & θ = arctan \frac{y}{x} \\ 0 \leq r , & 0 \leq θ < 2 π\end{matrix}$$

This encompasses four variables x, y, r and θ (which means corresponding definition and destructor atoms); four equations, and two inequalities. It can be established by any number of axiom atoms, maintained by any number of expression atoms, and tested by any number of assertion atoms.

Since invariants can have limited scope, they can transition from one to another for added obfuscation. The two-dimensional Cartesian/polar coordinate conversion invariant can segue to the three-dimensional Cartesian/cylindrical coordinate conversion invariant with the simple addition of the variable z. A transition from there to the three-dimensional Cartesian/spherical coordinate conversion invariant:

$$\begin{matrix}x = ρ cos θ sin φ , & ρ = \sqrt{{x}^{2} + {y}^{2} + {z}^{2}} , & 0 \leq ρ \\ x = ρ sin θ sin φ , & θ = arctan \frac{y}{z} , & 0 \leq θ \leq 2 π \\ z = ρ cos φ , & φ = arccos ( \frac{z}{\sqrt{{x}^{2} + {y}^{2} + {z}^{2}}} ) , & 0 \leq φ \leq π\end{matrix}$$

can be done by means of a conversion invariant:

$$ρ = \frac{r}{sin φ}$$

An invariant need not overly restrict the values its variables can acquire. Consider an invariant derived from the solution to quadratic equations:

$${b}^{2} - 4 a c \geq 0$$

$$x = \frac{- b \pm \sqrt{{b}^{2} - 4 a c}}{2 a}$$

Axiom, expression and assertion atoms could be written that provide no statistical correlations between the values of a, b, c, and possibly x.

Obfuscation's enemies are hackers who might expect cryptographic design in the software they are trying to hack, so invariants could be made to prey on that expectation. For example, an invariant could be

k=i×j

where i and j are large prime numbers. An axiom atom could be a simple yet inefficient algorithm to find large prime numbers, such as

| | |
|---|---|
| int i = floor; | // find a prime larger than |
| floor | |
| boolean prime; | |
| do { | |

| | |
|---|---|
| prime = true; | // assume it's prime |

for (int index = 2; index <= sqrt(i);
index++)

if (i % index == 0) {

| | |
|---|---|
| prime = false; | |
| i++; | // try the next |
| integer | |
| break; | |

}

} while (prime != true) ;

Other invariants could be derived from common portions of cryptography.

The claims appended hereto are meant to cover modifications and changes within the scope and spirit of the present invention

1. A method of generating software code that prevents important processing portions of said software code from being reverse engineered, the method comprising:
a) providing basic software code components, called atoms, wherein only some of the atoms are adapted to perform an intended processing of the software code;
b) randomly shuffling and duplicating the atoms; and
c) building combinations of the atoms, called molecules, by randomly selecting the atoms and appending the selected atoms to each molecule;
wherein a software code comprising a plurality of software code molecules is generated, the software code containing multiple copies of all atoms, including the atoms performing the intended processing of the software code.

2. The method of claim 1, wherein the atoms doing operations not important for the software code at issue execute a nontrivial algorithm and/or test a nontrivial condition.

3. The method of claim 1, wherein all atoms are evenly represented within statistical tolerance.

4. The method of claim 1, wherein random selection of the atoms comprises determination of dependencies of the atoms and addition of components and definitions in case said components and definitions have not been previously added.

5. The method of claim 1, wherein each atom is part of one of a definition atom group, axiom atom group, expression atom group, assertion atom group or destructor atom group.

6. The method of claim 5, wherein each atom group contains:
i) obfuscator atoms, whose behavior has no bearing on operation or functionality of what is being obfuscated;
ii) facilitators that implement a desired functionality; and
iii) terminators that detect tampering.

7. The method of claim 6, wherein:
an obfuscator atom of a definition atom group defines variables used by obfuscators;
an obfuscator atom of an axiom atom group establishes an invariant;
an obfuscator atom of an expression atom group maintains an invariant;
an obfuscator atom of an assertion atom group fails on false invariant;
an obfuscator atom of a destructor atom group destroys variables used by obfuscators;
a facilitator atom of a definition atom group defines variables used by facilitators;
a facilitator atom of an axiom atom group establishes an invariant needed for desired functionality;
a facilitator atom of an expression atom group implements desired functionality while maintaining an invariant;
a facilitator atom of an assertion atom group fails on valid error condition;
a facilitator atom of a destructor atom group destroys variables used by facilitators;
a terminator atom of a definition atom group defines variables used by terminators;
a terminator atom of an axiom atom group establishes an invariant that detects tampering;
a terminator atom of an expression atom group maintains a tampering detecting invariant;
a terminator atom of an assertion atom group fails when it detects tampering; and
a terminator atom of a destructor atom group destroys variables used by terminators.

8. The method of claim 7, wherein the building of the molecules comprises keeping track of active and inactive variables.
